(19) United States
(12) Patent Application Publication
(10) Pub. No.: US 2002/0177482 A1
(43) Pub. Date: Nov. 28, 2002

(54) Remote control receiver

(76) Inventors: Richard Cheong, Tsuen Wan (HK); Chris Gibbons, Clearwater Bay (HK); Kin Shing Yu, Tai Po (HK)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/021,739

(22) Filed: Dec. 12, 2001

Related U.S. Application Data
(63) Continuation-in-part of application No. 09/670,076, filed on Sep. 26, 2000.

(51) Int. Cl. G06F 17/00

(52) U.S. Cl. 463/39

(57) ABSTRACT

A receiver unit for use with an electronic device such as a games player, digital video disc player or the like having a port for connection of a peripheral control device comprises: first connection means (18) allowing releasable electrical connection of the unit with the port of the electronic device; second connection means (20) allowing releasable connection of a peripheral control device, such as games pad or joystick; signal detection means (26) for receiving a signal from a remote transmitter such as a hand-held remote control device; and processing means (24) connected to said first and second connection means and to said signal detection means (26) to process received signals and supply them to said first connection means (18).

### REFERENCE TO RELATED APPLICATIONS

This application is a continuation-in-part of U.S. patent application Ser. No. 09/670,076, filed Sep. 26, 2000, the contents of which are incorporated by reference herein.

### BACKGROUND OF THE INVENTION

The present invention relates to a receiver for use with an electronic apparatus such as a games player, digital video disc or compact disc player or the like for receiving control signals from a remote control device.

It is well-known to provide remote control of such an electronic device, and audio and video players and television sets commonly have integrated receivers which receive control signals from a hand-held remote control device transmitted by an infra-red (IR) or radio frequency (RF) transmitter. Such a device typically controls functions such as on-off, play, stop, fast-forward etc.

In an electronic apparatus such as electronic games player or video players or similar, ports are available for connection of peripheral control devices. In a games player a port is provided for connection of a control pad or joystick. The pad or joystick provides the requisite input signals required in playing a game; for example there is a spatial controller providing signals representative of an x-y position or x-y-z position for effecting movement of an “object” through space, as well as one or more switches providing discrete signals, for example used to represent an individual event, such as the firing of a missile.

The present invention seeks to provide a plug-in unit which allows both remote control, and control by a peripheral control device.

### SUMMARY OF THE INVENTION

According to a first aspect of the invention there is provided a receiver unit for use with an electronic apparatus such as a games player, digital video disc player or the like having a port for connection of a peripheral control device, the receiver unit comprising: first connection means allowing releasable electrical connection with the port of the electronic apparatus; second connection means allowing releasable connection of a peripheral control device; signal detection means for receiving a signal from a remote transmitter; and processing means connected to said first and second connection means and to said signal detection means to process received signals and supply them to said first connection means.

The receiver unit allows the peripheral control device to remain connected whilst a remote control device is used, avoiding the need to either remove the peripheral control device when one wants remote control, or to remove the receiver unit when one requires the peripheral control device to be connected.

Preferably, the first and second connection means have an identical sequence of connection pins or sockets in the sense that the first and second connection means have the same order or sequence of individual pin connections, although reversed when each is view front-on.

In the preferred embodiment the processing means is preferably adapted to provide direct connection of the first and second connection means in the absence of a received signal from said signal detection means, and is adapted to block transmission to said first or second connecting means of signals supplied to said second or first connection means respectively, on receipt of signals from a remote transmitter or the electronic apparatus respectively. The processing means may block said transmission for a predetermined period of time after transmission of said signals from a remote transmitter, for example for a time of 4 seconds.

The processing means is adapted to detect the presence of a peripheral device. On the initial detection of the presence of a peripheral device, device-identifying data representative of the device functionality is communicated to the electronic apparatus in a device initialisation process. Then, on receipt of a signal from the remote transmitter the processing means communicates with the electronic apparatus identifying data indicative of the attached device configured in a different mode, in a mode-change initialisation process. Moreover, on cessation of said signal from the remote transmitter the processing means communicates with the electronic apparatus identifying data indicative of the attached device functionality in a mode which corresponds to that on initial detection, in a mode change initialisation process. This technique allows for a very rapid initialisation switching between data from the remote transmitter and data from the peripheral device. This mode change initialisation process takes less than about 0.5 second.

The processing means may further be adapted such that in the absence of a peripheral device on receipt of a signal from a remote transmitter the processing means blocks the transmission of signals between first and second connection means, and communicates to the electronic apparatus identifying data representing a virtual peripheral device and effects with the electronic apparatus a device initialisation process on the basis of this data. The identifying data representing a virtual peripheral device is equivalent to identifying data for a known existing peripheral device.

The processing means preferably comprises a first processor adapted to receive incoming signals from the remote transmitter and to convert them to a protocol required by the electronic device, and a multiplexing processor to provide a switchable connection between the first and second connection means, said switching thereof being controllable by said first processor.

The receiver unit may operate on infra-red or radio frequency.

### DESCRIPTION OF THE DRAWINGS

Embodiments of the invention are now described, by way of example only, with reference to the following drawings in which:

FIG. 1 shows schematically an electronic apparatus with a receiver unit in accordance with an embodiment of the invention attached;

FIG. 2 is an external front perspective view of the receiver unit;

FIG. 3 is an external rear view of the receiver unit of FIG. 2;

FIG. 4(a) is a circuit diagram for the receiver unit; and FIG. 4(b) shows the unit's connector pin configurations.

### DETAILED DESCRIPTION OF THE PREFERRED EMBODIMENTS

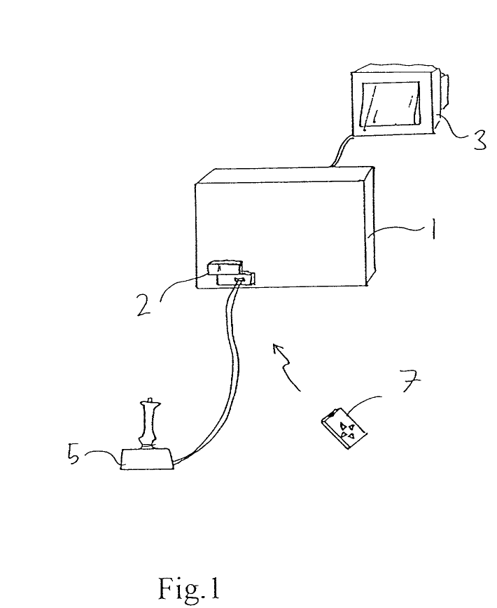

FIG. 1 is an overview of a system including an electronic apparatus 1 which may be a video games player or digital video disk player, personal computer or the like. Attached thereto is a monitor 3 which may be a television, PC or video monitor. A receiver unit 2 in accordance with an embodiment of the invention is plugged into a data socket of the electronic apparatus 1. A peripheral control device 5 such as a games pad, joystick, mouse, trackball, steering wheel-type controller or other control device allowing directional control is connected to the receiver unit as discussed below. A remote control device 7 is used to communicate with the receiver unit to provide remote control of the electronic apparatus.

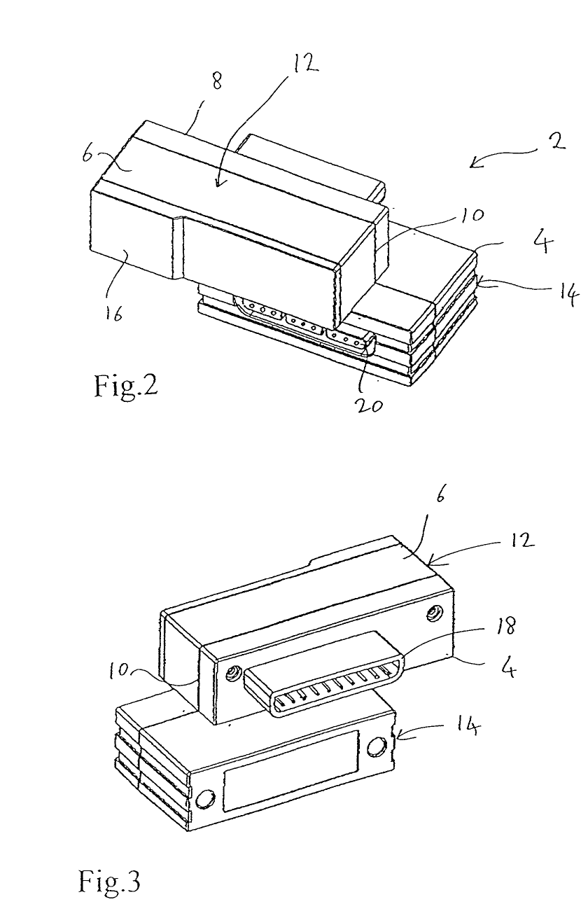

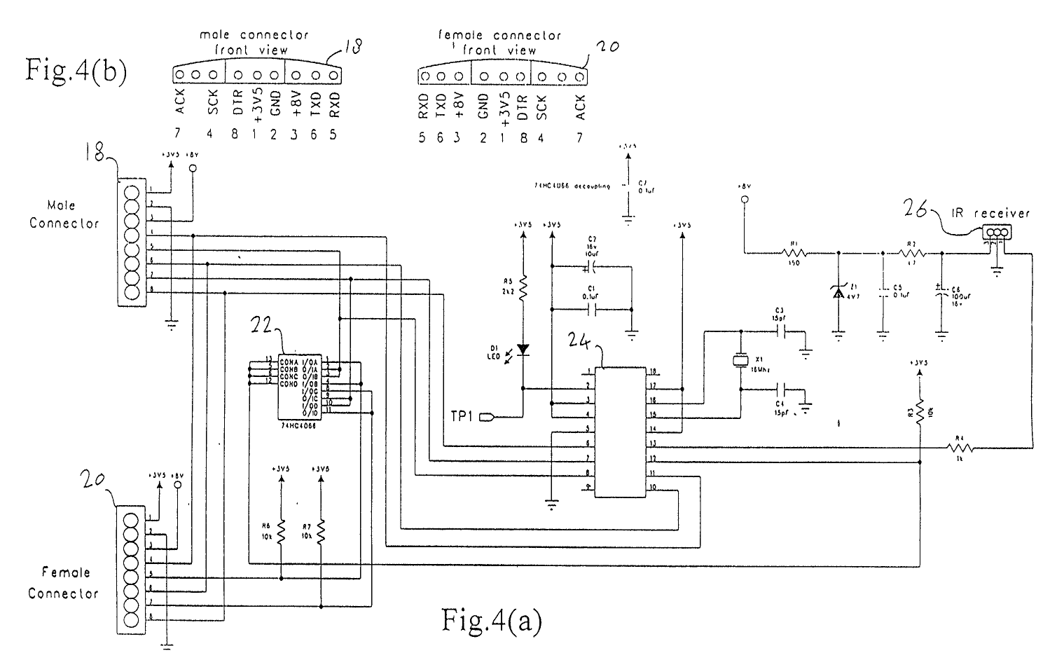

Turning to FIGS. 2 and 3, these show external views of the receiver unit 2 in accordance with an embodiment of the invention. The receiver unit 2 has a housing 4 comprising front and rear housing parts 6, 8 joined at line 10. The housing has upper and lower sections 12, 14. The upper section 12 houses an infra-red receiving element behind a translucent plastics front cover 16 of material which is transparent to infra-red. At the rear of the upper section is a male connector 18 which fits into a data socket on the player, the connector comprising nine adjacent pins as illustrated in FIG. 4(a) and (b) and discussed further below. At the front of the lower section 14 is a female socket 20 having nine pin-receiving sockets for receiving a serial connector of a peripheral control device such as a games pad or joystick, mouse, trackball steering wheel-type controller or other games control pad.

Turning now to FIGS. 4(a) and (b), the receiver unit circuitry is illustrated. FIG. 4(b) shows the physical arrangement of pins of the male connector 18 and female connector 20 as viewed in the directions illustrated in FIGS. 3 and 2 respectively, the connector pins being shown schematically in FIG. 4(a) not in accordance with physical position for reasons of clarity. The circuit includes a first integrated circuit chip 22 which serves as a multiplexing or switching means between the male 18 and female 20 connectors. This may be a 4066 IC having four quad bilateral switches therein. A second integrated circuit chip 24 which is a programmable microcontroller (MCU) or alternatively a CPU or application specific integrated circuit (ASIC) serves to process the received incoming signals from a remote control device as well as to control the switching of the IC 22 as discussed further below. As a further alternative the functions of IC 22 and MCU 24 could be combined in an ASIC.

A third integrated circuit chip 26 is an infra-red receiver circuit. This is entirely conventional including an infrared sensitive element for receiving an infra-red transmission from a remote. transmitter such as hand-held remote control device 7 and including a band pass filter to exclude possible ambient signals, and demodulation means. Typically, 38 kHz is adopted as the transmission carrier frequency. Connected to the infra-red receiver circuit is a voltage regulator providing a stabilised +5V supply for the chip 26.

The MCU 24 is provided with a stabilised +3V power supply to pins 3, 4, 17 and 14. An oscillator X1 provides the system clock via pins 15 and 16. Pin 2 is connected to light emitting diode D1 which serves to emit a visual acknowledge signal confirming receipt of a signal from the remote control device.

For both the male and female connectors 18, 20 pins 1, 2 and 3 of each connector go to +3V, ground and +8V respectively. Pins 4 are connected to each other and to the MCU 24 at pin 11 receiving a clock signal. Pins 6 are connected directly to each other and to MCU 24 at pin 10, this line being “transmit data” line carrying signals for example for controlling a vibratory effect or a recoil effect on a joystick. Pin 5 of the female connector 20 is connected to multiplexer IC 22 at pins 1 and 4, whilst the input to pin 5 of the male connector is connected to IC 22 pins 2 and 3. These lines carry “received data”, being data from the remote control device or the peripheral device. Pin 8 of MCU 24 is connected directly to this “received data” line. Pins 8 of the male and female connectors are connected directly to each other and to the MCU at pin 6, this line carrying a “data terminal ready” signal, used to ensure data is not transmitted when the apparatus is otherwise busy with other operations and unable to receive data. Pin 7 of the female connector is connected to pins 8 and 11 of IC 22 receiving an “acknowledge” signal used as part of establishment of the handshake connection between communicating devices. Pin 7 of the male connector is connected to MCU 24 pin 7 and pins 9 and 10 of IC 22 carrying “acknowledge” signals.

Pin 5 and pin 7 of the female connector are also each connected through resistors (R6 on pin 5 and R7 on pin 7) to +3V which serve to stabilise the voltage high levels on the respective lines.

In operation, the unit 2 is connected with the male connector 18 fitted into the data port of the games player or digital video disk player or similar, whilst a peripheral control device such as a pad or joystick etc. as described above which would otherwise be connected directly to the data port of the games player, is connected to the female connector 20. When the unit 2 is initially plugged into the electronic apparatus the MCU 24 receives power from the apparatus and immediately relinquishes switching control so that (in the absence of any signal from a remote control device) the unit is “enabled” with female and male connectors connected with corresponding pins either directly connected (pins 4, 6, 8) or connected through multiplexer IC 22 (pins 5, 7) which simply provides internal direct connection without any signal modification. In this way the functionality of the peripheral device is maintained unchanged. As is conventional, the electronic apparatus (games player etc.) will go through a device initialisation process with the peripheral device during which a peripheral device ID is communicated to the apparatus and a series of set-up commands exchanged. The device ID is usually a fixed bit-length code which is unique to the type of peripheral device, allowing the apparatus to identify the precise functionality of the peripheral device, typically through a look-up procedure of device functionalities of different commercially available devices stored in the apparatus or imported into the apparatus. For example, the device ID may include code representing the number of modes it can emulate, number of motors, button configurations, maximum current consumption. The set-up commands may also involve a checking procedure of the peripheral device functionalities, e.g., motor functions, sensor functions. This device initialisation takes usually 0.4 to 20 seconds depending on the nature and complexity of the device. During an initial phase of this device initialisation (typically within the first second) the MCU 24 monitors the pin 7 for any bus activity to establish if a peripheral device is indeed connected, and having confirmed that one is, stops monitoring the pin 7 for the existence of the peripheral device.

The unit 2 remains “enabled” (that is allowing “pass through” of signals) with electronic apparatus and peripheral device communicating until an IR signal is received from a valid remote control transmitter 7. In the remote control transmitter device 7 a plurality of buttons are provided for a user to control various functions of the electronic apparatus. For example, in a digital video disk player the functions may include one or more of on/off, mute, play, fast forward, reverse, stop, next track, last track, disk eject, display menu etc. When an infra-red signal from an appropriate remote control transmitter device is received by the infra-red receiver IC 26 the input signal is first demodulated in IC 26. A 16 bit redundancy check technique or similar can be utilised to avoid transmission errors. The cleaned demodulated signal is then passed to MCU 24 (via pin 13). MCU 24 decodes the signal and/or translates the signals into a protocol required by the games player which includes a device recognition check to confirm the signal is a valid signal from a valid transmitter. Assuming the signal is verified as valid the electronic apparatus will go through an initialisation process with the MCU 24 of reduced length referred-to here as a “mode change” initialisation. Such a type of initialisation is utilised for example in controllers which have functions which can be changed by a user, such as switching between analogue and digital modes on a games pad. Unlike a full device initialisation procedure where a complete device ID and functionality check is effected, in the “mode change” initialisation data representative of the same device operated in a different configuration may be all that is communicated between MCU 24 and the electronic apparatus, which is necessarily a significantly reduced amount of data. Thus, the MCU 24 takes the identity of a peripheral device having the same characteristics as the attached peripheral device, but set in a different mode. This mode change-type initialisation takes less than a second (typically 0.15 to 0.5 sec) in contrast to the full device initialisation described above. MCU 24 communicates with IC 22 switching this to “disable” the unit 2 disconnecting the “received data” connection through the IC 22 (pins 5) and the “acknowledge data” connection through the IC 22 (pins 7). Thus, any data signals from or to the peripheral control device are blocked. The communication link between transmitter 7 and electronic apparatus is thereby established and data signals from the output of MCU 24 (pin 8) in the appropriate protocol for the device are fed directly to the male connector 18 (pin 5) and thereby to the electronic apparatus.

At the same time, LED D1 is activated providing a visual indicator to a user of the receipt of a signal from the remote control device. Whilst signals continue to be transmitted from the remote control device, the unit 2 remains “disabled” with multiplexer IC 22 blocking data transmission from the female connector. A time control in the MCU 24 serves to fully reconnect female and male connectors and hence the peripheral device in the absence of any signals received by the IR receiver in a predetermined period, for example 4 seconds. More particularly, in the absence of valid IR data for a 4 second period the electronic apparatus makes another mode change-type initialisation communicating shortened ID data packets representative of the peripheral device, following which data is received from the peripheral device.

The MCU 24 keeps continuously checking for the peripheral device in a periodical manner. If at any time the peripheral device is disconnected, the electronic apparatus detects the absence of peripheral device ID. Any IR signal received initially triggers the MCU 24 to “disable” the pass through of signals through the unit 2. The MCU 24 is programmed to internally assume the existence of or essentially adopt the identity of a “virtual peripheral device” having the ID of a recognised controller, for example a regular games pad, and remain enabled. Before accepting data from the IR transmitter the electronic apparatus will go through a full device initialisation with the MCU 24 as it adopts this identity as a virtual peripheral device. In the event that no valid IR data is received for a period of about 4 seconds the unit is “enabled” again. In the event that the peripheral device is replaced by a different peripheral device (for example, a steering wheel replaces a game pad) the electronic apparatus undergoes a full device initialisation directly with the replacement peripheral device, the unit 2 remaining “enabled”.

The receiver unit 2 thereby allows for remote control of basic functions of the games player such as on/off, play, fast forward etc as described above whilst the peripheral control device remains physically connected, automatically blocking the operation of the peripheral control device whilst the remote control device is being utilised, and reconnecting when the remote device is no longer being utilised.

In the event that the receiver unit 2 with no peripheral device attached is plugged into the electronic apparatus the unit 2 is “enabled”, releasing the switching control to the electronic apparatus which attempts to effect a device initialisation. Within an initial phase (typically within the first second) of the device initialisation the MCU 24 monitors the pin 7 to detect any bus activity to determine if a peripheral device is connected. If it is not, the MCU 24 recognizes that no peripheral device is connected, and MCU 24 continues to monitor pin 7 until a peripheral device is connected; once it is, the device initialisation described above is effected, with the ID of the peripheral device being communicated with the electronic apparatus.

In the event that an IR signal is received when no peripheral device is connected a device initialisation is effected, the MCU 24 adopts the identity of the virtual peripheral device i.e., the recognized controller (such as a regular games pad) with the device initialisation based on the ID of the virtual peripheral device.

Although a receiver unit 2 has been described which operates as an infra-red receiver it is equally appropriate to utilise radio frequency transmission. In this case IR receiver 26 is replaced by a radio frequency receiver with associated electronics as is well understood in the art in order to receive and demodulate a signal transmitted at a radio frequency.

1. A receiver unit for use with an electronic apparatus having a port for connection of a peripheral control device, the receiver unit comprising:
a first connector allowing releasable electrical connection of the receiver unit with the port of the electronic apparatus;
a second connector allowing releasable connection of a peripheral control device;
a signal detector for receiving a signal from a remote transmitter; and
a processor connected to said first and second connectors and to said signal detector to process received signals and supply them to said first connector.

2. A receiver unit according to claim 1 wherein the first connector and second connector comprise connection ports having an identical sequence of pins or sockets.

3. A receiver unit according to claim 1 wherein the processor is adapted to provide direct connection of the first and second connectors in the absence of a received signal from said signal detector.

4. A receiver unit according to claim 1 wherein the processor is adapted to block transmission to said first connector of signals supplied to said second connector, from a peripheral control device connected thereto on receipt of signals from a remote transmitter.

5. A receiver unit according to claim 4 wherein the processor is adapted to block said transmission for a predetermined period of time after transmission of said signals from the remote transmitter.

6. A receiver unit according to claim 5 wherein the predetermined time is less than 5 minutes.

7. A receiver unit according to claim 4 wherein the processor is adapted to block transmission to said second connector of signals supplied to said first connector from the electronic apparatus on receipt of signals from the remote transmitter.

8. A receiver unit according to claim 1 wherein the processor detects the presence of a peripheral device.

9. A receiver unit according to claim 8 wherein on initial detection of the presence of a peripheral device, device-identifying data representative of the device functionality is communicated to the electronic apparatus in a device initialisation process.

10. A receiver unit according to claim 9 wherein on receipt of a signal from the remote transmitter the processor communicates to the electronic apparatus identifying data indicative of the attached device configured in a different mode, in a mode change initialisation process.

11. A receiver unit according to claim 10 wherein on cessation of said signal from the remote transmitter the processor communicates to the electronic apparatus identifying data indicative of the attached device functionality in a mode which corresponds to that on initial detection, in a mode change initialisation process.

12. A receiver unit according to claim 10 wherein the mode change initialisation process is of shorter duration than the device initialisation process.

13. A receiver unit according to claim 12 wherein the mode change initialisation process takes less than about 0.5 seconds.

14. A receiver unit according to claim 1 wherein the processor is adapted such that in the absence of a peripheral device on receipt of a signal from a remote transmitter the processor blocks the transmission of signals between first and second connectors, and communicates to the electronic apparatus identifying data representing a virtual peripheral device and effects with the electronic apparatus a device initialisation process on the basis of this data.

15. A receiver unit according to claim 14 wherein the identifying data representing a virtual peripheral device is equivalent to identifying data for a known existing peripheral device.

16. A receiver unit according to claim 1 wherein the processor is adapted to receive incoming signals from the remote transmitter and to convert them to a protocol required by the electronic apparatus, and to provide a switchable connection between the first and second connectors.

17. A receiver unit according to claim 16 wherein the processor comprises a first processor which receives the incoming signals from the remote transmitter and converts them to the requisite protocol and a multiplexing processor to provide the switchable connection between the first and second connector, the switching being controlled by the first processor.

18. A receiver unit according to claim 17 wherein said first processor is a programmable microcontroller unit.

19. A receiver unit according to claim 17 wherein said first processor is an application specific integrated circuit.

20. A receiver unit according to claim 1 wherein the signal detector is adapted to receive a wirelessly transmitted signal.

21. A receiver unit according to claim 20 wherein the signal detector is an infra-red receiver.

22. A receiver unit according to claim 20 wherein the signal detector is a radio frequency receiver.

23. A receiver unit for use with an electronic apparatus having a port for connection of a peripheral control device, the receiver unit comprising:
first connection means allowing releasable electrical connection of the receiver unit with the port of the electronic apparatus;
second connection means allowing releasable connection of a peripheral control device;
signal detection means for receiving a signal from a remote transmitter; and
processing means connected to said first and second connection means and to said signal detection means to process received signals and supply them to said first connection means, the processing means being adapted to block transmission to said first connection means of signals supplied to said second connection means from a peripheral control device connected thereto on receipt of signals from a remote transmitter, the processing means being adapted to block said transmission for a predetermined period of time after transmission of said signals from the remote transmitter, the predetermined period of time being less than about 5 minutes.

24. A receiver unit for use with an electronic apparatus having a port for connection of a peripheral control device, the receiver unit comprising:
first connection means allowing releasable electrical connection of the receiver unit with the port of the electronic apparatus;
second connection means allowing releasable connection of a peripheral control device;
signal detection means for receiving a signal from a remote transmitter; and
processing means connected to said first and second connection means and to said signal detection means to process received signals and supply them to said first connection means, the processing means being adapted to block transmission to said first connection means of signals supplied to said second connection means from a peripheral control device connected thereto on receipt of signals from a remote transmitter and being adapted to block transmission to said second connection means of signals supplied to said first connection means from the electronic apparatus on receipt of signals from the remote transmitter.

25. A receiver unit for use with an electronic apparatus having a port for connection of a peripheral control device, the receiver unit comprising:
first connection means allowing releasable electrical connection of the receiver unit with the port of the electronic apparatus;
second connection means allowing releasable connection of a peripheral control device;
signal detection means for receiving a signal from a remote transmitter; and
processing means connected to said first and second connection means and to said signal detection means to process received signals and supply them to said first connection means, the processing means detecting the presence of a peripheral device.

26. A receiver unit according to claim 25 wherein on initial detection of the presence of a peripheral device, device-identifying data representative of the device functionality is communicated to the electronic apparatus in a device initialisation process.

27. A receiver unit according to claim 26 wherein on receipt of a signal from the remote transmitter the processing means communicates to the electronic apparatus identifying data indicative of the attached device configured in a different mode, in a mode change initialisation process.

28. A receiver unit according to claim 27 wherein on cessation of said signal from the remote transmitter the processing means communicates to the electronic apparatus identifying data indicative of the attached device functionality in a mode which corresponds to that on initial detection, in a mode change initialisation process.

29. A receiver unit according to claim 27 wherein the mode change initialisation process is of shorter duration than the device initialisation process.

30. A receiver unit according to claim 29 wherein the mode change initialisation process takes less than about 0.5 seconds.

31. A receiver unit for use with an electronic apparatus having a port for connection of a peripheral control device, the receiver unit comprising:
first connection means allowing releasable electrical connection of the receiver unit with the port of the electronic apparatus;
second connection means allowing releasable connection of a peripheral control device;
signal detection means for receiving a signal from a remote transmitter; and
processing means connected to said first and second connection means and to said signal detection means to process received signals and supply them to said first connection means, the processing means being adapted such that in the absence of a peripheral device on receipt of a signal from a remote transmitter the processing means blocks the transmission of signals between first and second connection means, and communicates to the electronic apparatus identifying data representing a virtual peripheral device and effects with the electronic apparatus a device initialisation process on the basis of this data.

32. A receiver unit according to claim 31 wherein the identifying data representing a virtual peripheral device is equivalent to identifying data for a known existing peripheral device.

33. A receiver unit for use with an electronic apparatus having a port for connection of a peripheral control device, the receiver unit comprising:
first connection means allowing releasable electrical connection of the receiver unit with the port of the electronic apparatus;
second connection means allowing releasable connection of a peripheral control device;
signal detection means for receiving a signal from a remote transmitter; and
processing means connected to said first and second connection means and to said signal detection means to process received signals and supply them to said first connection means, the processing means being adapted to receive incoming signals from the remote transmitter and to convert them to a protocol required by the electronic apparatus and to provide a switchable connection between the first and second connection means.

34. A receiver unit according to claim 33 wherein the processing means comprises a first processor which receives the incoming signals from the remote transmitter and converts them to the requisite protocol and a multiplexing processor to provide the switchable connection between the first and second connector, the switching being controlled by the first processor, said first processor being an application specific integrated circuit.
